(19) United States
(12) Patent Application Publication
(10) Pub. No.: US 2025/0095344 A1
(43) Pub. Date: Mar. 20, 2025

(54) IMAGE INTERPOLATION FOR MULTI-SENSOR TRAINING OF FEATURE DETECTION MODELS

(71) Applicant: QUALCOMM Incorporated, San Diego, CA (US)

(72) Inventor: Andreas EIDEHALL, Linköping (SE)

(21) Appl. No.: 18/469,213

(22) Filed: Sep. 18, 2023

(51) Int. Cl. G06V 10/80; G06T 3/40; G06V 20/70

(52) U.S. Cl. CPC G06V 10/80; G06T 3/4007; G06T 3/4046; G06V 20/70

(57) ABSTRACT

Image interpolation techniques for multi-sensor training of feature detection models are disclosed. The techniques can include obtaining a detection-and-ranging (DAR) frame captured by a DAR sensor, obtaining a first image frame captured at a first time by a camera and a second image frame captured at a second time by the camera, wherein at a capture time of the DAR frame, a field of view (FOV) of the DAR sensor overlaps an FOV of the camera, and wherein the capture time of the DAR frame is between the first time and the second time, interpolating based on the first image frame and the second image frame to create an interpolated image frame, wherein a nominal capture time of the interpolated image frame corresponds to the capture time of the DAR frame, and training a feature detection model using the DAR frame and the interpolated image frame.

### BACKGROUND

### 1. Field of Disclosure

Aspects of the present disclosure generally relate to feature detection, and more particularly to multi-sensor training of feature detection models.

### 2. Description of Related Art

In a variety of contexts, apparatuses such as vehicles, factory or warehouse equipment, machines, or apparatuses of other types may be configured to conduct feature detection in conjunction with ordinary operation. Based on data provided by a camera, a light detection and ranging (lidar) sensor, a radio detection and ranging (radar) sensor, or a sensor of another type, a processing system of such an apparatus can detect the presence of features—such as objects, surfaces, edges, boundaries, substances, obstacles, markings, and the like—in a field of view (FOV) of the sensor and estimate the positions of any detected features within the FOV. Using multiple types of sensors for feature detection can yield improved results, as different types of sensors can compensate for each other's shortcomings. For instance, feature detection based on image data provided by a camera may be fairly resilient to the presence of even heavy precipitation, but may be significantly compromised by low-light conditions. On the other hand, feature detection based on data provided by a lidar sensor may be hampered by the presence of precipitation, but may be relatively unaffected by low-light conditions, and may support more precise distance-to-point estimations those based on camera imaging. As such, using a camera and a lidar sensor in concert to conduct feature detection may produce better results than using either type of sensor by itself.

### BRIEF SUMMARY

An example method for multi-sensor training of a feature detection model, according to this disclosure, may include obtaining a detection-and-ranging (DAR) frame captured by a DAR sensor, obtaining a first image frame captured at a first time by a camera and a second image frame captured at a second time by the camera, wherein at a capture time of the DAR frame, a field-of-view (FOV) of the DAR sensor overlaps an FOV of the camera, and wherein the capture time of the DAR frame is between the first time and the second time, interpolating based on the first image frame and the second image frame to create an interpolated image frame, wherein a nominal capture time of the interpolated image frame corresponds to the capture time of the DAR frame, and training a feature detection model using the DAR frame and the interpolated image frame.

An example apparatus for multi-sensor training of a feature detection model, according to this disclosure, may include at least one processor and at least one memory communicatively coupled with the at least one processor and storing processor-readable code that, when executed by the at least one processor, is configured to obtain a DAR frame captured by a DAR sensor, obtain a first image frame captured at a first time by a camera and a second image frame captured at a second time by the camera, wherein at a capture time of the DAR frame, an FOV of the DAR sensor overlaps an FOV of the camera, and wherein the capture time of the DAR frame is between the first time and the second time, interpolate based on the first image frame and the second image frame to create an interpolated image frame, wherein a nominal capture time of the interpolated image frame corresponds to the capture time of the DAR frame, and train a feature detection model using the DAR frame and the interpolated image frame.

An example apparatus for multi-sensor training of a feature detection model, according to this disclosure, may include means for obtaining a DAR frame captured by a DAR sensor, means for obtaining a first image frame captured at a first time by a camera and a second image frame captured at a second time by the camera, wherein at a capture time of the DAR frame, an FOV of the DAR sensor overlaps an FOV of the camera, and wherein the capture time of the DAR frame is between the first time and the second time, means for interpolating based on the first image frame and the second image frame to create an interpolated image frame, wherein a nominal capture time of the interpolated image frame corresponds to the capture time of the DAR frame, and means for training a feature detection model using the DAR frame and the interpolated image frame.

An example non-transitory computer-readable medium, according to this disclosure, may store instructions for multi-sensor training of a feature detection model, the instructions including code for obtain a DAR frame captured by a DAR sensor, obtain a first image frame captured at a first time by a camera and a second image frame captured at a second time by the camera, wherein at a capture time of the DAR frame, an FOV of the DAR sensor overlaps an FOV of the camera, and wherein the capture time of the DAR frame is between the first time and the second time, interpolate based on the first image frame and the second image frame to create an interpolated image frame, wherein a nominal capture time of the interpolated image frame corresponds to the capture time of the DAR frame, and train a feature detection model using the DAR frame and the interpolated image frame.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a block diagram illustrating a first example operating environment, according to aspects of the disclosure.

FIG. 2 is a diagram illustrating example image frame and DAR frame capture timings, according to aspects of the disclosure.

FIG. 3 is a diagram illustrating an example scheme for utilizing image interpolation techniques for multi-sensor training of a feature detection model.

FIG. 4 is a block diagram illustrating a second example operating environment, according to aspects of the disclosure.

FIG. 5 is a block diagram showing an example method for image interpolation for multi-sensor training of a feature detection model, according to aspects of the disclosure.

FIG. 6 is a block diagram of an embodiment of a computer system, which can be utilized in embodiments as described herein.

FIG. 7 is a diagram illustrating example components of a vehicle, according to aspects of the disclosure.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways.

Various aspects generally relate to feature detection, and more particularly to multi-sensor training of feature detection models. Some aspects more specifically relate to image interpolation techniques for multi-sensor training of feature detection models. According to some aspects, a feature detection system—such as for a vehicle, factory or warehouse equipment, machine, or apparatus of another type—can interpolate based on image frames captured by a camera to create interpolated image frames that are time-aligned with detection-and-ranging (DAR) frames captured by a sensor of another type, such as a radar sensor or a lidar sensor. According to some aspects, the feature detection system can use a generative machine-learning model—such as a generative adversarial network (GAN) model—that can accept, as inputs, first and second image frames captured at first and second respective times, and can generate, as an output, an interpolated image frame having a nominal capture time between those first and second times. The nominal capture time can correspond to a capture time of a DAR frame with which the interpolated image frame is to be time-aligned. According to some aspects, the time-aligned interpolated image frames and DAR frames can be used to train one or more feature detection models, which can include an image-based detection model, a DAR-based detection model, a multi-sensor fusion (MSF) detection model, or any combination thereof. According to aspects of the disclosure, by generating time-aligned image frames and using them for feature detection model training, the training and evaluation of detection models across sensor modalities can be made more accurate and more efficient.

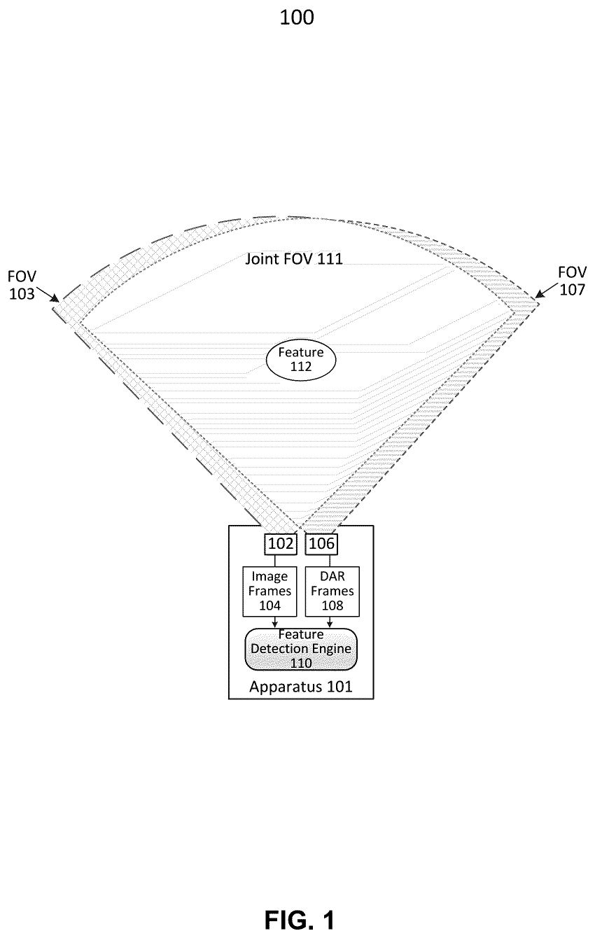

FIG. 1 is a block diagram illustrating an example operating environment 100 in which image interpolation techniques for multi-sensor training of feature detection models may be implemented according to aspects of the disclosure. In operating environment 100, an apparatus 101 includes a camera 102. The camera 102 can be usable to capture image frames 104 that depict a portion of three-dimensional space corresponding to a field-of-view (FOV) 103 of the camera 102. Apparatus 101 also includes a detection-and-ranging (DAR) sensor 106, which is a sensor of a different type than camera 102. The DAR sensor 106 can be usable to capture DAR frames 108 that depict a portion of three-dimensional space corresponding to an FOV 107 of the DAR sensor 106. The DAR sensor 106 can be a non-camera sensor of any type suitable for capturing data that indicates or reflects physical characteristics of the contents of that portion of three-dimensional space, such as presences and positions of objects, surfaces, substances, obstacles, and the like. In some examples, the DAR sensor 106 can be a radio detection and ranging (radar) sensor. In some other examples, the DAR sensor 106 can be a light detection and ranging (lidar) sensor. In yet other examples, the DAR sensor 106 can be a non-camera sensor of another type.

Apparatus 101 can include an feature detection engine 110, which can analyze image frames 104, DAR frames 108, or both, to detect features—such as objects, surfaces, edges, boundaries, substances, obstacles, markings, and the like—in FOV 103, FOV 105, or both. In some examples, feature detection engine 110 can implement an image-based detection model to detect features in the FOV 103 of the camera 102 by analyzing image frames 104. In some examples, feature detection engine 110 can additionally or alternatively implement a DAR-based detection model to detect features in the FOV 107 of the DAR sensor 106 by analyzing DAR frames 108.

Shown in FIG. 1 is a joint FOV 111 that represents a region of overlap between the FOVs 103 and 107 of the camera 102 and the DAR sensor 106, respectively. If a feature 112 is located at a position within joint FOV 111 at a time t, and the camera 102 and DAR sensor 106 capture an image frame 104 and a DAR frame 108, respectively, at the time t, then the presence of the feature 112 may be reflected in both the image frame 104 and the DAR frame 108. For example, the feature 112 may be visible in the image frame 104, and points corresponding to positions on the feature 112 may be present among those of a point cloud in the DAR frame 108.

According to aspects of the disclosure, various comparative characteristics of FOVs 103 and 107 relative to each other may be known to, or determinable by, apparatus 101. Such comparative characteristics can describe, for example, differences in the respective orientations of the camera 102 and the DAR sensor 106, positions of the of the respective focal points of the camera 102 and the DAR sensor 106 relative to each other, differences in the respective angular coverage of FOVs 103 and 107, or other characteristics. In some examples, based on such comparative characteristics, inter-sensor translation parameters can be derived (during a calibration procedure, dynamically during operation, or both) that can be used to identify correspondences between positions in image frames 104 and DAR frames 108. For instance, given a position at which feature 112 appears in an image frame 104 captured at time t, feature detection engine 110 may be able to apply one or more inter-sensor translation parameters to identify, in a DAR frame 108 captured at time t, a corresponding position at which the feature 112 should appear.

According to aspects of the disclosure, it may be possible for apparatus 101 to obtain better feature detection results by leveraging the functionality of camera 102 and DAR sensor 106 in concert, using a multi-sensor fusion (MSF) feature detection model. In conjunction with performing feature detection according to an MSF feature detection model, feature detection engine 110 can analyze image frames 104 and DAR frames 108 in tandem. This can involve, for instance, analyzing an image frame 104 to provisionally detect features, identifying regions in a DAR frame 108 that correspond to regions in which the provisionally-detected features appear in the image frame 104, analyzing the identified regions in the DAR frame 108 to check for indications of the provisionally-detected features, and drawing conclusions regarding the provisionally-detected features based on what is found in those regions in the DAR frame 108. Such conclusions can include, for instance, conclusions regarding whether the provisionally-detected features are actually present, and conclusions regarding the dimensions, position, nature, or other attributes of provisionally-detected features that are actually present.

If the DAR frame 108 was captured at a same time as the image frame 104, then given the regions containing provisionally-detected features in the image frame 104, the feature detection engine 110 can apply inter-sensor translation parameters to identify the regions in which the provisionally-detected features can be expected to be found (and thus, the regions to be analyzed) in the DAR frame 108. However, if the DAR frame 108 and the image frame 104 were captured at different times, then the regions in which the provisionally-detected features can be expected to be found in the DAR frame 108 may differ from those indicated by the results of straightforward application of inter-sensor translation parameters, due to motion on the part of apparatus 101, motion on the part of the provisionally-detected features, or both.

According to aspects of the disclosure, the camera 102 and the DAR sensor 106 may capture image frames 104 and DAR frames 108 according to different respective timings that are not aligned with each other. As a result, with respect to any given image frame 104, it may be unlikely that feature detection engine 110 has access to a DAR frame 108 captured at a same time as that image frame 104. Likewise, with respect to any given DAR frame 108, it may be unlikely that feature detection engine 110 has access to an image frame 104 captured at a same time as that DAR frame 108.

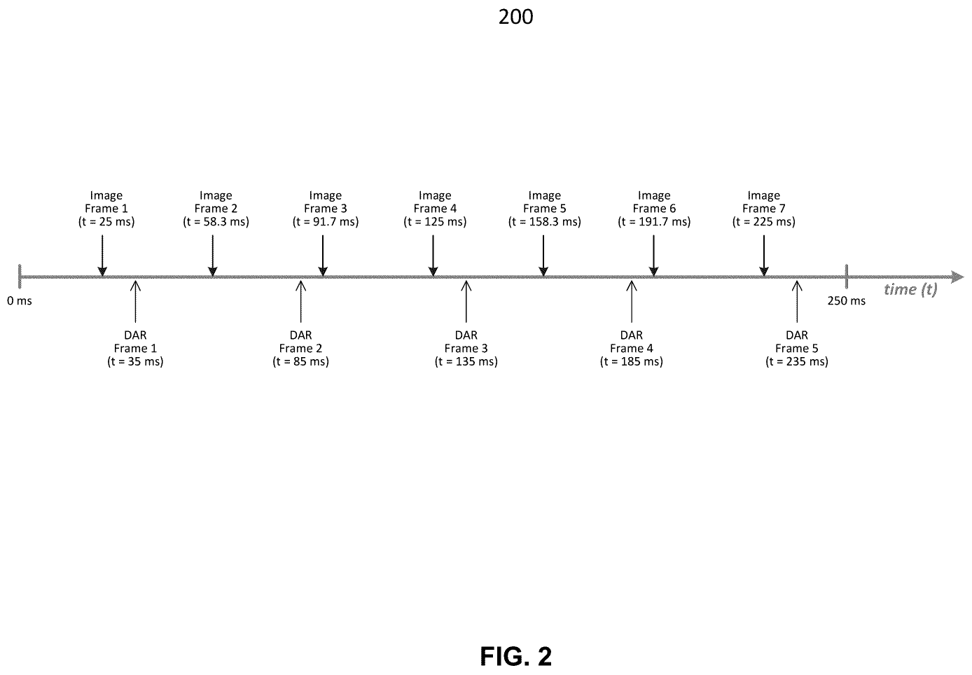

FIG. 2 is a timing diagram 200 illustrating example image frame and DAR frame capture timings, according to aspects of the disclosure. Timing diagram 200 depicts an example in which image frames are captured at a rate of 30 frames per second (fps), and DAR frames are captured at a rate of 20 frames per second. The horizontal axis represents time, and timings are shown over a time interval of 250 ms (one quarter of one second). Seven image frames are captured over the course of the 250 ms interval, the first of which is captured at time t=25 ms. Meanwhile, five DAR frames are captured, the first at time t=35 ms. As can be seen in FIG. 2, due to the unaligned timings of image frame capture and DAR frame capture, no image frame is captured at a same time as any DAR frame, and vice versa.

Disclosed herein are image interpolation techniques for multi-sensor training of feature detection models. According to aspects of the disclosure, the disclosed techniques can be implemented to support and enhance multi-sensor training of feature detection models under circumstances, such as those illustrated in FIG. 2, in which the capture timings of sensors used for capture of frames used to train the feature detection models are not aligned. In various examples, according to such techniques, a feature detection model training system can interpolate based on image frames captured by a camera to create interpolated image frames that are time-aligned with DAR frames captured by a DAR sensor, such as a lidar sensor or a radar sensor. In some examples, the feature detection model training system can create interpolated image frames using a generative machine-learning model, such as a generative adversarial network (GAN) model. According to aspects of the disclosure, the feature detection model training system can use such time-aligned DAR frames and interpolated image frames to train a feature detection model, such as an image-based feature detection model, a DAR-based feature detection model, or a multi-sensor fusion (MSF) feature detection model.

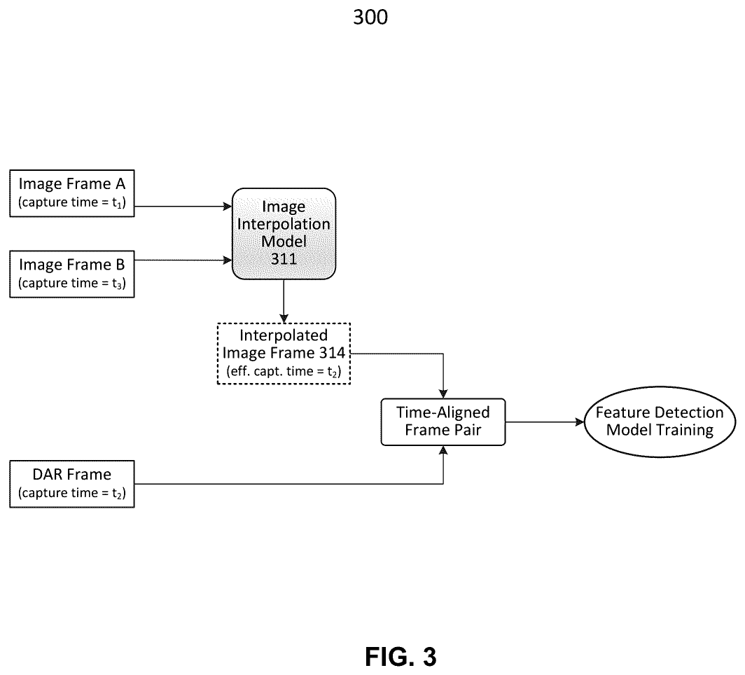

FIG. 3 is a diagram illustrating an example scheme 300 for utilizing image interpolation techniques for multi-sensor training of feature detection models. According to scheme 300, multiple image frames can be provided as inputs to an image interpolation model 311, which can be applied to create an interpolated image frame 314 having a nominal capture time that is aligned with a capture time that is aligned with a capture time of a DAR frame. The multiple image frames can include one or more image frames captured at times prior to the capture time of the DAR frame, and one or more image frames captured at times subsequent to the capture time of the DAR frame. In the particular example shown in FIG. 3, the multiple image frames provided as inputs to image interpolation model 311 include an image frame A captured at a time t₁ and an image frame B captured at a time t₃. Based on the image frames A and B, image interpolation model 311 is applied to create the interpolated image frame 314, which has a nominal capture time that is aligned with a capture time t₂ of a DAR frame, where the time t₂ is between the respective capture times t₁ and t₃ of the image frames A and B. According to aspects of the disclosure, the image interpolation model can be a generative machine-learning model. In some examples, the image interpolation model can be a generative adversarial network (GAN) model.

The DAR frame and the interpolated image frame can be provided, as a time-aligned frame pair, as input to one or more feature detection model training processes. The one or more feature detection model training processes can include, for instance, a process for training an image-based feature detection model, a process for training a DAR-based feature detection model, a process for training a multi-sensor fusion (MSF) feature detection model, or a combination thereof.

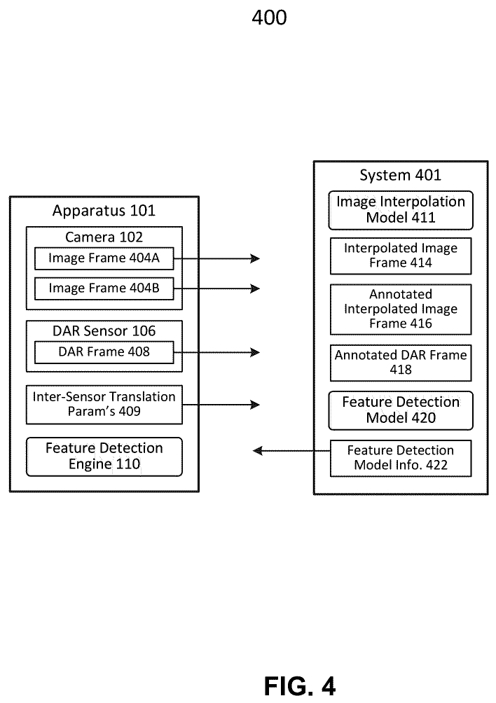

FIG. 4 is a block diagram illustrating an example operating environment 400, according to aspects of the disclosure. In operating environment 400, apparatus 101 of FIG. 1 may provide captured image frames and DAR frames to a system 401, for use in conjunction with implementing image interpolation techniques for multi-sensor training of feature detection models. In some examples, apparatus 101 can be a vehicle or other type of mobile apparatus, and can capture image frames and DAR frames as it travels. In some other examples, apparatus can correspond to stationary equipment, such as may be located in a factory, warehouse, or similar environment, and can capture image frames and DAR frames as persons, objects, vehicles, and the like travel in/through its vicinity. In some examples, system 401 can be a central system for receiving and analyzing image frames and DAR frames captured by a plurality of devices, of which apparatus 101 may be one. For instance, in some examples, system 401 may receive and analyze captured image frames and DAR frames from a plurality of vehicles, one of which is apparatus 101, or from a plurality of feature detection nodes (in a factory or warehouse, for instance), one of which corresponds to apparatus 101.

In operating environment 400, system 401 can obtain a DAR frame 408 captured by the DAR sensor 106 of apparatus 101, and can obtain image frames 404A and 404B captured at first and second times, respectively, by the camera 102 of apparatus 101. According to aspects of the disclosure, at a capture time of the DAR frame 408, the FOV of the DAR sensor 106 can overlap the FOV of the camera 102. In some examples, the FOVs of the DAR sensor 106 and the camera 102 can be static, such that the extent of their overlap does not vary as a function of time. In some other examples, the FOV of camera 102 can be static, but the DAR sensor 106 can be a rotating DAR scanner, such that its FOV rotates over time, and thus the extent of its overlap with the FOV of the camera 102 varies as a function of time.

According to aspects of the disclosure, the capture time of the DAR frame 408 can be between the first and second times at which image frame 404A and image frame 404B, respectively were captured by camera 102. In examples in which the FOV of DAR sensor 106 is static, the capture time of the DAR frame 408 can correspond to a time at which the DAR frame 408 was captured in its entirety. In some examples in which the FOV of DAR sensor 106 rotates, DAR sensor 106 can likewise correspond to a time at which the DAR frame 408 was captured in its entirety. However, in some other examples, as it rotates, DAR sensor 106 may collect DAR data (such as lidar or radar points) in a continuous fashion, such that the DAR frame 408 consists of (or corresponds to) DAR data collected over a time interval (rather than all at one time). In some such examples, the capture time of the DAR frame 408 can represent a point in time midway through the time interval over which the DAR data was collected.

According to aspects of the disclosure, system 401 can create an interpolated image frame 414 by interpolating based on the image frames 404A and 404B, using an image interpolation model 411. According to aspects of the disclosure, the image interpolation model 411 can be designed to generate, as interpolated image frame 414, an image frame that represents a prediction of what a hypothetical image frame captured by camera 102—at a nominal capture time between the actual respective capture times of the image frames 404A and 404B—would look like. According to aspects of the disclosure, system 401 can conduct interpolation using the image interpolation model 411 so as to obtain an interpolated image frame 414 having a nominal capture time that corresponds to the capture time of the DAR frame 408.

In some examples, the image interpolation model 411 can be a generative machine-learning model. For instance, in some examples, image interpolation model 411 can be a generative adversarial network (GAN) model. In some other examples, image interpolation model 411 can be a machine-learning model of another type, such as a diffusion model, a transformer model, a variational autoencoder (VAE) model, or a neural radiance field (NeRF) model.

In examples in which the FOV of DAR sensor 106 rotates, there can be a DAR capture timing gradient associated a motion rate of the FOV of DAR sensor 106 with respect to a dimension (such as a horizontal dimension, for example) in DAR frame 408. The DAR capture timing gradient can correspond to continuously-increasing capture times of data points along the dimension in question. In some examples, system 401 can conduct interpolation using the image interpolation model 411 so that there is an image capture timing gradient across that dimension in the interpolated image frame 414. System 401 can implement the image capture timing gradient to match the DAR capture timing gradient of the DAR frame 408, such that the associated capture times of points in the interpolated image frame 414 vary across the dimension in the same way as do those of points in the DAR frame 408.

According to aspects of the disclosure, system 401 can train a feature detection model 420 using the DAR frame 408 and the interpolated image frame 414. In some examples, system 401 can train the feature detection model 420 with reference to one or more inter-sensor translation parameters 409. Inter-sensor translation parameters 409 can include one or more parameters that can be used to identify correspondences between positions in DAR frame 408 and positions in interpolated image frame 414. In some examples, system 401 can obtain inter-sensor translation parameters 409 from apparatus 101. In some examples, inter-sensor translation parameters 409 can be derived during a calibration procedure for apparatus 101, dynamically during operation of apparatus 101, or a combination of both.

In some examples, the feature detection model 420 can be a DAR-based detection model. In some such examples, system 401 can use an image-based detection model to detect a feature in interpolated image frame 414, and can create an annotated interpolated image frame 416 by annotating interpolated image frame 414 to indicate a location of the feature in interpolated image frame 414. In some examples, system 401 can then train feature detection model 420 based on the DAR frame 408 and the annotated interpolated image frame 416. In some examples, the feature detection model 420 can be an image-based detection model. In some such examples, system 401 can use a DAR-based detection model to detect a feature in DAR frame 408, and can create an annotated DAR frame 418 by annotating DAR frame 408 to indicate a location of the feature in DAR frame 408. In some examples, system 401 can then train feature detection model 420 based on the interpolated image frame 414 and the annotated DAR frame 418. In some examples, system 401 can detect a feature in a joint FOV of camera 102 and DAR sensor 106 (for example, joint FOV 111 of FIG. 1) using a multi-sensor fusion (MSF) feature detection model.

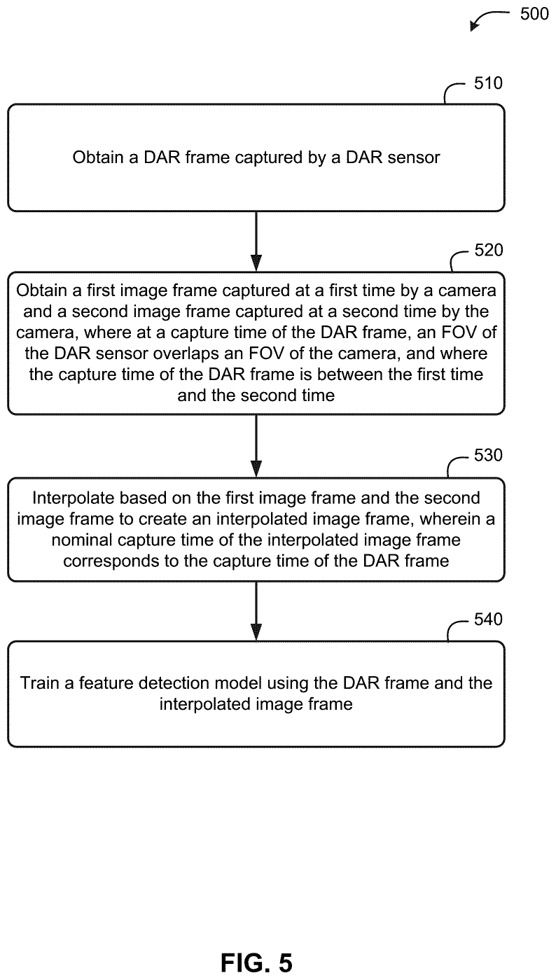

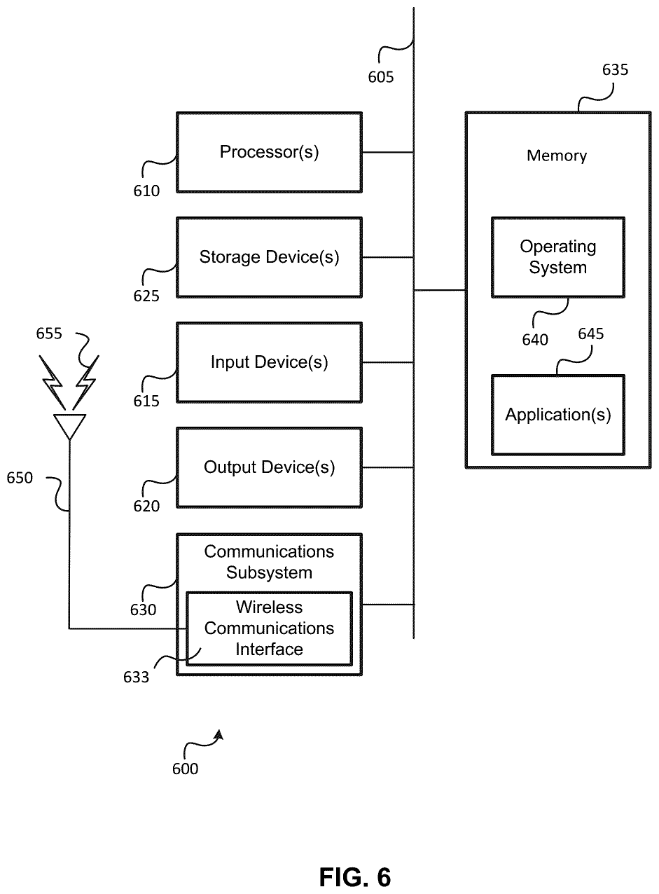

FIG. 5 is a block diagram showing an example method 500 for image interpolation for multi-sensor training of a feature detection model, according to aspects of the disclosure. According to aspects of the disclosure, means for performing the functionality illustrated in one or more of the blocks shown in FIG. 5 may be performed by hardware and/or software components of a computer system. Example components of a computer system are illustrated in FIG. 6, which is described in more detail below. In some examples, system 401 may perform the functionality illustrated in one or more of the blocks shown in FIG. 5 in operating environment 400 of FIG. 4.

At block 510, the functionality comprises obtaining a DAR frame captured by a DAR sensor. For example, in operating environment 400 of FIG. 4, system 401 may obtain a DAR frame 408 captured by DAR sensor 106 of apparatus 101. Means for performing functionality at block 510 may comprise a bus 605, processor(s) 610, storage device(s) 625, communications subsystem 630, memory 635, and/or other components of a computer system, as illustrated in FIG. 6. In some examples, the DAR sensor can be a radar sensor. In some other examples, the DAR sensor can be a lidar sensor. In some examples, the camera and the DAR sensor can be sensors of a vehicle. For example, in operating environment 400 of FIG. 4, apparatus 101 can be a vehicle.

At block 520, the functionality comprises obtaining a first image frame captured at a first time by a camera and a second image frame captured at a second time by the camera, where at a capture time of the DAR frame, an FOV of the DAR sensor overlaps an FOV of the camera, and where the capture time of the DAR frame is between the first time and the second time. For example, in operating environment 400 of FIG. 4, system 401 may obtain image frames 404A and 404B captured by camera 102 of apparatus 101, where at a capture time of DAR frame 408 by DAR sensor 106, an FOV of DAR sensor 106 overlaps an FOV of camera 102. Means for performing functionality at block 520 may comprise a bus 605, processor(s) 610, storage device(s) 625, communications subsystem 630, memory 635, and/or other components of a computer system, as illustrated in FIG. 6. At a capture time of the DAR frame, an FOV

At block 530, the functionality comprises interpolating based on the first image frame and the second image frame to create an interpolated image frame, wherein a nominal capture time of the interpolated image frame corresponds to the capture time of the DAR frame. For example, in operating environment 400 of FIG. 4, system 401 may interpolate based on image frames 404A and 404B to create interpolated image frame 414, and a nominal capture time of interpolated image frame 414 may correspond to a capture time of DAR frame 408. Means for performing functionality at block 530 may comprise a bus 605, processor(s) 610, storage device(s) 625, communications subsystem 630, memory 635, and/or other components of a computer system, as illustrated in FIG. 6.

In some examples, the interpolating based on the first image frame and the second image frame can include interpolating using a generative machine-learning model. In some such examples, the generative machine-learning model can be a generative adversarial network (GAN) model. For example, in operating environment 400 of FIG. 4, image interpolation model 411 can be a generative machine-learning model such as a GAN model. In some examples, the interpolating based on the first image frame and the second image frame can include implementing an image capture timing gradient across a dimension in the interpolated image frame based on a DAR capture timing gradient associated with the dimension in the DAR frame. For example, in operating environment 400 of FIG. 4, system 401 can implement an image capture timing gradient across the horizontal dimension in interpolated image frame 414 based on a DAR capture timing gradient associated with the horizontal dimension in DAR frame 408. In some such examples, the DAR capture timing gradient can be associated with a motion rate of an FOV of the DAR sensor with respect to the dimension. For instance, continuing the previous example, the DAR sensor 106 that captures the DAR frame 408 can be a rotating DAR scanner, and the DAR capture timing gradient associated with the horizontal dimension in DAR frame 408 can be associated with a rate of rotation of an FOV of the DAR sensor 106.

At block 540, the functionality comprises training a feature detection model using the DAR frame and the interpolated image frame. For example, in operating environment 400 of FIG. 4, system 401 may train feature detection model 420 using DAR frame 408 and interpolated image frame 414. Means for performing functionality at block 540 may comprise a bus 605, processor(s) 610, storage device(s) 625, communications subsystem 630, memory 635, and/or other components of a computer system, as illustrated in FIG. 6.

In some examples, the feature detection model can be a DAR-based detection model. In some such examples, training the feature detection model using the DAR frame and the interpolated image frame can include detecting a feature in the interpolated image frame using an image-based detection model, annotating the interpolated image frame to indicate a location of the feature in the interpolated image frame, and training the DAR-based detection model based on the DAR frame and the annotated interpolated image frame. For example, in operating environment 400 of FIG. 4, feature detection model 420 can be a DAR-based detection model, and system 401 can detect a feature in interpolated image frame 414 using an image-based detection model, obtain annotated interpolated image frame 416 by annotating interpolated image frame 414 to indicate a location of the feature in interpolated image frame 414, and train feature detection model 420 based on the annotated interpolated image frame 416 and the DAR frame 408.

In some examples, the feature detection model can be an image-based detection model. In some such examples, training the feature detection model using the DAR frame and the interpolated image frame can include detecting a feature in the DAR frame using an DAR-based detection model, annotating the DAR frame to indicate a location of the feature in the DAR frame, and training the image-based detection model based on the interpolated image frame and the annotated DAR frame. For example, in operating environment 400 of FIG. 4, feature detection model 420 can be an image-based detection model, and system 401 can detect a feature in DAR frame 408 using a DAR-based detection model, obtain annotated DAR frame 418 by annotating DAR frame 408 to indicate a location of the feature in DAR frame 408, and train feature detection model 420 based on the interpolated image frame 414 and the annotated DAR frame 418.

In some examples, a feature in a joint FOV of the camera and the DAR sensor can be detected based on the DAR frame and the interpolated image frame, using a multi-sensor fusion (MSF) feature detection model. For example, in operating environment 400 of FIG. 4, system 401 can detect a feature in a joint FOV of the camera 102 and the DAR sensor 106 of apparatus 101 based on the DAR frame 408 and the interpolated image frame 414, using an MSF feature detection model.

FIG. 6 is a block diagram of an embodiment of a computer system 600, which may be used, in whole or in part, to provide the functions of one or more components as described in the embodiments herein. According to aspects of the disclosure, computer system 600 can be used in some examples to implement system 401 of FIG. 4, method 500 of FIG. 5, or both. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner. In addition, it can be noted that components illustrated by FIG. 6 can be localized to a single device and/or distributed among various networked devices, which may be disposed at different geographical locations.

The computer system 600 is shown comprising hardware elements that can be electrically coupled via a bus 605 (or may otherwise be in communication, as appropriate). The hardware elements may include processor(s) 610, which may comprise without limitation one or more general-purpose processors, one or more special-purpose processors (such as digital signal processing chips, graphics acceleration processors, and/or the like), and/or other processing structure, which can be configured to perform one or more of the methods described herein. The computer system 600 also may comprise one or more input devices 615, which may comprise without limitation a mouse, a keyboard, a camera, a microphone, and/or the like; and one or more output devices 620, which may comprise without limitation a display device, a printer, and/or the like.

The computer system 600 may further include (and/or be in communication with) one or more non-transitory storage devices 625, which can comprise, without limitation, local and/or network accessible storage, and/or may comprise, without limitation, a disk drive, a drive array, an optical storage device, a solid-state storage device, such as a RAM and/or ROM, which can be programmable, flash-updateable, and/or the like. Such storage devices may be configured to implement any appropriate data stores, including without limitation, various file systems, database structures, and/or the like. Such data stores may include database(s) and/or other data structures used store and administer messages and/or other information to be sent to one or more devices via hubs, as described herein.

The computer system 600 may also include a communications subsystem 630, which may comprise wireless communication technologies managed and controlled by a wireless communication interface 633, as well as wired communication technologies (such as Ethernet, coaxial communications, universal serial bus (USB), and the like). The wired communication technologies can be managed and controlled by a wired communication interface (not shown in FIG. 6). The wireless communication interface 633 may comprise one or more wireless transceivers that may send and receive wireless signals 655 (e.g., signals according to 5G NR or LTE) via wireless antenna(s) 650. Thus the communications subsystem 630 may comprise a modem, a network card (wireless or wired), an infrared communication device, a wireless communication device, and/or a chipset, and/or the like, which may enable the computer system 600 to communicate on any or all of the communication networks described herein to any device on the respective network, including a User Equipment (UE), base stations and/or other TRPs, and/or any other electronic devices described herein. Hence, the communications subsystem 630 may be used to receive and send data as described in the embodiments herein.

In many embodiments, the computer system 600 will further comprise a working memory 635, which may comprise a RAM or ROM device, as described above. Software elements, shown as being located within the working memory 635, may comprise an operating system 640, device drivers, executable libraries, and/or other code, such as one or more applications 645, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the storage device(s) 625 described above. In some cases, the storage medium might be incorporated within a computer system, such as computer system 600. In other embodiments, the storage medium might be separate from a computer system (e.g., a removable medium, such as an optical disc), and/or provided in an installation package, such that the storage medium can be used to program, configure, and/or adapt a general purpose computer with the instructions/code stored thereon. These instructions might take the form of executable code, which is executable by the computer system 600 and/or might take the form of source and/or installable code, which, upon compilation and/or installation on the computer system 600 (e.g., using any of a variety of generally available compilers, installation programs, compression/decompression utilities, etc.), then takes the form of executable code.

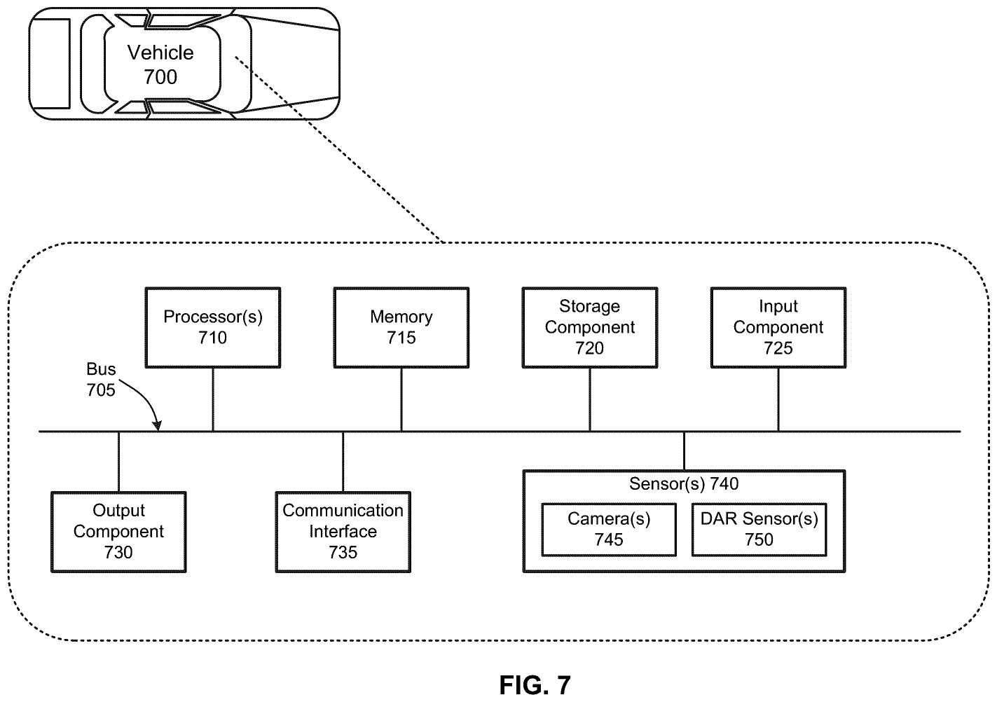

FIG. 7 is a diagram illustrating example components of a vehicle 700, in accordance with the present disclosure. According to aspects of the disclosure, vehicle 700 can correspond to an implementation of apparatus 101 of FIG. 1. As shown in FIG. 7, vehicle 700 may include a bus 705, processor(s) 710, a memory 715, a storage component 720, an input component 725, an output component 730, a communication interface 735, sensor(s) 740, and/or the like. The number and arrangement of components shown in FIG. 7 are provided as an example. In practice, the vehicle 700 may include additional components, fewer components, different components, or differently arranged components than those shown in FIG. 7.

The bus 705 includes a component that permits communication among the components of vehicle 700. Processor(s) 710 can be implemented in hardware, firmware, software, or a combination of hardware, firmware, and software. The processor(s) 710 may include a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some aspects, the processor(s) 710 include one or more processors capable of being programmed to perform a function. The memory 715 includes a random access memory (RAM), a read only memory (ROM), and/or another type of dynamic or static storage device (such as a flash memory, a magnetic memory, and/or an optical memory) that stores information and/or instructions for use by the processor(s) 710.

The storage component 720 stores information and/or software related to the operation and use of vehicle 700. For example, the storage component 720 may include a hard disk (such as a magnetic disk, an optical disk, a magneto-optic disk, and/or a solid state disk), a compact disc (CD), a digital versatile disc (DVD), a floppy disk, a cartridge, a magnetic tape, and/or another type of non transitory computer-readable medium, along with a corresponding drive.

The input component 725 includes a component that permits vehicle 700 to receive information, such as via user input (such as a touch screen display, a keyboard, a keypad, a mouse, a button, a switch, and/or a microphone). Additionally, or alternatively, the input component 725 may include a component for determining a position or a location of the vehicle 700 (such as a global positioning system (GPS) component, a global navigation satellite system (GNSS) component, and/or the like) a sensor for sensing information (such as an accelerometer, a gyroscope, an actuator, another type of position or environment sensor, and/or the like). The output component 730 includes a component that provides output information from the vehicle 700 (such as a display, a speaker, a haptic feedback component, an audio or visual indicator, and/or the like).

The communication interface 735 includes a transceiver-like component (such as a transceiver and/or a separate receiver and transmitter) that enables the vehicle 700 to communicate with other devices, such as via a wired connection, a wireless connection, or a combination of wired and wireless connections. The communication interface 735 may permit the vehicle 700 to receive information from another device and/or provide information to another device. For example, the communication interface 735 may include an Ethernet interface, an optical interface, a coaxial interface, an infrared interface, a radio frequency interface, a universal serial bus (USB) interface, a wireless local area interface (such as a Wi-Fi interface), a cellular network interface, and/or the like.

The sensor(s) 740 include one or more devices capable of sensing characteristics associated with the vehicle 700. The sensor(s) 740 may include one or more integrated circuits (such as on a packaged silicon die) and/or one or more passive components of one or more flex circuits to enable communication with one or more components of the vehicle 700. The sensor(s) 740 may include an optical sensor that has a field of view in which it may determine one or more characteristics of an environment of the vehicle 700. The sensor(s) 740 may include one or more cameras 745. For example, the sensor(s) 740 may include a camera 745 that is configured to capture image frames for use in feature detection using a detection model trained according to techniques disclosed herein for image interpolation for multi-sensor training of feature detection models. The sensor(s) 740 may include low-power device(s) (such as device(s) that consume less than ten milliwatts (mW) of power) that have always-on capability while the vehicle 700 is powered on.

Additionally, or alternatively, the sensor(s) 740 may include magnetometer (such as a Hall effect sensor, an anisotropic magneto-resistive (AMR) sensor, a giant magneto-resistive sensor (GMR), and/or the like), a location sensor (such as a global positioning system (GPS) receiver, a local positioning system (LPS) device (such as that uses triangulation, multi-lateration, and/or the like), and/or the like), a gyroscope (such as a micro-electro-mechanical systems (MEMS) gyroscope or a similar type of device), an accelerometer, a speed sensor, a motion sensor, an infrared sensor, a temperature sensor, a pressure sensor, and/or the like.

The sensor(s) 740 may include one or more detection and ranging (DAR) sensors 750. In some examples, the DAR sensor(s) 750 may include one or more radar sensors that can measure reflected radio waves to generate radar data that can be used to determine the range, angle, and/or velocity of objects, surfaces, structures, and/or the like. In some examples, the one or more radar sensors can include one or more millimeter wave (mmWave) radar sensors. In some examples, the DAR sensor(s) 750 may include one or more lidar sensors that can measure reflected light pulses to generate lidar data that can be used to estimate distances of objects from the lidar sensor(s).

The vehicle 700 may perform one or more processes described herein. The vehicle 700 may perform these processes based on the processor(s) 710 executing software instructions stored by a non-transitory computer-readable medium, such as the memory 715 and/or the storage component 720. A computer-readable medium is defined herein as a non-transitory memory device. A memory device includes memory space within a single physical storage device or memory space spread across multiple physical storage devices.

Software instructions may be read into the memory 715 and/or the storage component 720 from another computer-readable medium or from another device via the communication interface 735. When executed, software instructions stored in the memory 715 and/or the storage component 720 may cause the processor(s) 710 to perform one or more processes described herein. Additionally, or alternatively, hardwired circuitry may be used in place of or in combination with software instructions to perform one or more processes described herein. Thus, aspects described herein are not limited to any specific combination of hardware circuitry and software.

In some aspects, the vehicle 700 includes means for performing one or more processes described herein and/or means for performing one or more operations of the processes described herein. In some aspects, such means may include one or more components of the vehicle 700 described in connection with FIG. 7, such as the bus 705, the processor(s) 710, the memory 715, the storage component 720, the input component 725, the output component 730, the communication interface 735, and/or the sensor(s) 740.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1. A method for multi-sensor training of a feature detection model, including obtaining a detection-and-ranging (DAR) frame captured by a DAR sensor, obtaining a first image frame captured at a first time by a camera and a second image frame captured at a second time by the camera, where at a capture time of the DAR frame, a field of view (FOV) of the DAR sensor overlaps an FOV of the camera, and where the capture time of the DAR frame is between the first time and the second time, interpolating based on the first image frame and the second image frame to create an interpolated image frame, where a nominal capture time of the interpolated image frame corresponds to the capture time of the DAR frame, and training the feature detection model using the DAR frame and the interpolated image frame.

Clause 2. The method of clause 1, where the interpolating based on the first image frame and the second image frame includes interpolating using a generative machine learning model.

Clause 3. The method of clause 2, where the generative machine learning model is a generative adversarial network (GAN) model.

Clause 4. The method of any of clauses 1 to 3, where the interpolating based on the first image frame and the second image frame includes implementing an image capture timing gradient across a dimension in the interpolated image frame based on a DAR capture timing gradient associated with the dimension in the DAR frame.

Clause 5. The method of clause 4, where the DAR capture timing gradient is associated with a motion rate of the FOV of the DAR sensor with respect to the dimension.

Clause 6. The method of any of clauses 1 to 5, where the feature detection model is a DAR-based detection model, and training the feature detection model using the DAR frame and the interpolated image frame includes detecting a feature in the interpolated image frame using an image-based detection model, annotating the interpolated image frame to indicate a location of the feature in the interpolated image frame, and training the DAR-based detection model based on the DAR frame and the annotated interpolated image frame.

Clause 7. The method of any of clauses 1 to 5, where the feature detection model is an image-based detection model, and training the feature detection model using the DAR frame and the interpolated image frame includes detecting a feature in the DAR frame using a DAR-based detection model, annotating the DAR frame to indicate a location of the feature in the DAR frame, and training the image-based detection model based on the interpolated image frame and the annotated DAR frame.

Clause 8. The method of any of clauses 1 to 7, further including detecting a feature in a joint FOV of the camera and the DAR sensor based on the DAR frame and the interpolated image frame, using a multi sensor fusion (MSF) feature detection model.

Clause 9. The method of any of clauses 1 to 8, where the DAR sensor is a radio detection and ranging (radar) sensor.

Clause 10. The method of any of clauses 1 to 8, where the DAR sensor is a light detection and ranging (lidar) sensor.

Clause 11. The method of any of clauses 1 to 10, where the camera and the DAR sensor are sensors of a vehicle.

Clause 12. An apparatus for multi-sensor training of a feature detection model, including at least one processor, and at least one memory communicatively coupled with the at least one processor and storing processor-readable code that, when executed by the at least one processor, is configured to obtain a detection-and-ranging (DAR) frame captured by a DAR sensor, obtain a first image frame captured at a first time by a camera and a second image frame captured at a second time by the camera, where at a capture time of the DAR frame, a field of view (FOV) of the DAR sensor overlaps an FOV of the camera, and where the capture time of the DAR frame is between the first time and the second time, interpolate based on the first image frame and the second image frame to create an interpolated image frame, where a nominal capture time of the interpolated image frame corresponds to the capture time of the DAR frame, and train the feature detection model using the DAR frame and the interpolated image frame.

Clause 13. The apparatus of clause 12, where to interpolate based on the first image frame and the second image frame, the processor-readable code is, when executed by the at least one processor, configured to interpolate using a generative machine learning model.

Clause 14. The apparatus of clause 13, where the generative machine learning model is a generative adversarial network (GAN) model.

Clause 15. The apparatus of any of clauses 12 to 14, where to interpolate based on the first image frame and the second image frame, the processor-readable code is, when executed by the at least one processor, configured to implement an image capture timing gradient across a dimension in the interpolated image frame based on a DAR capture timing gradient associated with the dimension in the DAR frame.

Clause 16. The apparatus of clause 15, where the DAR capture timing gradient is associated with a motion rate of the FOV of the DAR sensor with respect to the dimension.

Clause 17. The apparatus of any of clauses 12 to 16, where the feature detection model is a DAR-based detection model, and where to train the feature detection model using the DAR frame and the interpolated image frame, the processor-readable code is, when executed by the at least one processor, configured to detect a feature in the interpolated image frame using an image-based detection model, annotate the interpolated image frame to indicate a location of the feature in the interpolated image frame, and train the DAR-based detection model based on the DAR frame and the annotated interpolated image frame.

Clause 18. The apparatus of any of clauses 12 to 16, where the feature detection model is an image-based detection model, and where to train the feature detection model using the DAR frame and the interpolated image frame, the processor-readable code is, when executed by the at least one processor, configured to detect a feature in the DAR frame using a DAR-based detection model, annotate the DAR frame to indicate a location of the feature in the DAR frame, and train the image-based detection model based on the interpolated image frame and the annotated DAR frame.

Clause 19. The apparatus of any of clauses 12 to 18, where the processor readable code is, when executed by the at least one processor, further configured to detect a feature in a joint FOV of the camera and the DAR sensor based on the DAR frame and the interpolated image frame, using a multi sensor fusion (MSF) feature detection model.

Clause 20. The apparatus of any of clauses 12 to 19, where the DAR sensor is a radio detection and ranging (radar) sensor.

Clause 21. The apparatus of any of clauses 12 to 19, where the DAR sensor is a light detection and ranging (lidar) sensor.

Clause 22. The apparatus of any of clauses 12 to 21, where the camera and the DAR sensor are sensors of a vehicle.

Clause 23. An apparatus for multi-sensor training of a feature detection model, including means for obtaining a detection-and-ranging (DAR) frame captured by a DAR sensor, means for obtaining a first image frame captured at a first time by a camera and a second image frame captured at a second time by the camera, where at a capture time of the DAR frame, a field of view (FOV) of the DAR sensor overlaps an FOV of the camera, and where the capture time of the DAR frame is between the first time and the second time, means for interpolating based on the first image frame and the second image frame to create an interpolated image frame, where a nominal capture time of the interpolated image frame corresponds to the capture time of the DAR frame, and means for training the feature detection model using the DAR frame and the interpolated image frame.

Clause 24. The apparatus of clause 23, where the means for interpolating based on the first image frame and the second image frame includes means for interpolating using a generative machine learning model.

Clause 25. The apparatus of clause 24, where the generative machine learning model is a generative adversarial network (GAN) model.

Clause 26. The apparatus of any of clauses 23 to 25, where the means for interpolating based on the first image frame and the second image frame includes means for implementing an image capture timing gradient across a dimension in the interpolated image frame based on a DAR capture timing gradient associated with the dimension in the DAR frame.

Clause 27. The apparatus of clause 26, where the DAR capture timing gradient is associated with a motion rate of the FOV of the DAR sensor with respect to the dimension.

Clause 28. The apparatus of any of clauses 23 to 27, where the feature detection model is a DAR-based detection model, and the means for training the feature detection model using the DAR frame and the interpolated image frame includes means for detecting a feature in the interpolated image frame using an image-based detection model, means for annotating the interpolated image frame to indicate a location of the feature in the interpolated image frame, and means for training the DAR-based detection model based on the DAR frame and the annotated interpolated image frame.

Clause 29. The apparatus of any of clauses 23 to 27, where the feature detection model is an image-based detection model, and the means for training the feature detection model using the DAR frame and the interpolated image frame includes means for detecting a feature in the DAR frame using a DAR-based detection model, means for annotating the DAR frame to indicate a location of the feature in the DAR frame, and means for training the image-based detection model based on the interpolated image frame and the annotated DAR frame.

Clause 30. The apparatus of any of clauses 23 to 29, further including means for detecting a feature in a joint FOV of the camera and the DAR sensor based on the DAR frame and the interpolated image frame, using a multi sensor fusion (MSF) feature detection model.

Clause 31. The apparatus of any of clauses 23 to 30, where the DAR sensor is a radio detection and ranging (radar) sensor.

Clause 32. The apparatus of any of clauses 23 to 30, where the DAR sensor is a light detection and ranging (lidar) sensor.

Clause 33. The apparatus of any of clauses 23 to 32, where the camera and the DAR sensor are sensors of a vehicle.

Clause 34. A non-transitory computer-readable medium storing instructions for multi sensor training of a feature detection model, the instructions including code to obtain a detection-and-ranging (DAR) frame captured by a DAR sensor, obtain a first image frame captured at a first time by a camera and a second image frame captured at a second time by the camera, where at a capture time of the DAR frame, a field of view (FOV) of the DAR sensor overlaps an FOV of the camera, and where the capture time of the DAR frame is between the first time and the second time, interpolate based on the first image frame and the second image frame to create an interpolated image frame, where a nominal capture time of the interpolated image frame corresponds to the capture time of the DAR frame, and train the feature detection model using the DAR frame and the interpolated image frame.

Clause 35. The non-transitory computer-readable medium of clause 34, where to interpolate based on the first image frame and the second image frame, the instructions include code to interpolate using a generative machine learning model.

Clause 36. The non-transitory computer-readable medium of clause 35, where the generative machine learning model is a generative adversarial network (GAN) model.

Clause 37. The non-transitory computer-readable medium of any of clauses 34 to 36, where to interpolate based on the first image frame and the second image frame, the instructions include code to implement an image capture timing gradient across a dimension in the interpolated image frame based on a DAR capture timing gradient associated with the dimension in the DAR frame.

Clause 38. The non-transitory computer-readable medium of clause 37, where the DAR capture timing gradient is associated with a motion rate of the FOV of the DAR sensor with respect to the dimension.

Clause 39. The non-transitory computer-readable medium of any of clauses 34 to 38, where the feature detection model is a DAR-based detection model, and where to train the feature detection model using the DAR frame and the interpolated image frame, the instructions include code to detect a feature in the interpolated image frame using an image-based detection model, annotate the interpolated image frame to indicate a location of the feature in the interpolated image frame, and train the DAR-based detection model based on the DAR frame and the annotated interpolated image frame.

Clause 40. The non-transitory computer-readable medium of any of clauses 34 to 38, where the feature detection model is an image-based detection model, and where to train the feature detection model using the DAR frame and the interpolated image frame, the instructions include code to detect a feature in the DAR frame using a DAR-based detection model, annotate the DAR frame to indicate a location of the feature in the DAR frame, and train the image-based detection model based on the interpolated image frame and the annotated DAR frame.

Clause 41. The non-transitory computer-readable medium of any of clauses 34 to 40, where the instructions further include code to detect a feature in a joint FOV of the camera and the DAR sensor based on the DAR frame and the interpolated image frame, using a multi sensor fusion (MSF) feature detection model.

Clause 42. The non-transitory computer-readable medium of any of clauses 34 to 41, where the DAR sensor is a radio detection and ranging (radar) sensor.

Clause 43. The non-transitory computer-readable medium of any of clauses 34 to 41, where the DAR sensor is a light detection and ranging (lidar) sensor.

Clause 44. The non-transitory computer-readable medium of any of clauses 34 to 43, where the camera and the DAR sensor are sensors of a vehicle.

What is claimed is:

1. A method for multi-sensor training of a feature detection model, comprising:
obtaining a detection-and-ranging (DAR) frame captured by a DAR sensor;
obtaining a first image frame captured at a first time by a camera and a second image frame captured at a second time by the camera, wherein at a capture time of the DAR frame, a field-of-view (FOV) of the DAR sensor overlaps an FOV of the camera, and wherein the capture time of the DAR frame is between the first time and the second time;
interpolating based on the first image frame and the second image frame to create an interpolated image frame, wherein a nominal capture time of the interpolated image frame corresponds to the capture time of the DAR frame; and
training the feature detection model using the DAR frame and the interpolated image frame.

2. The method of claim 1, wherein the interpolating based on the first image frame and the second image frame includes interpolating using a generative machine-learning model.

3. The method of claim 2, wherein the generative machine-learning model is a generative adversarial network (GAN) model.

4. The method of claim 1, wherein the interpolating based on the first image frame and the second image frame includes implementing an image capture timing gradient across a dimension in the interpolated image frame based on a DAR capture timing gradient associated with the dimension in the DAR frame.

5. The method of claim 4, wherein the DAR capture timing gradient is associated with a motion rate of the FOV of the DAR sensor with respect to the dimension.

6. The method of claim 1, wherein the feature detection model is a DAR-based detection model, and training the feature detection model using the DAR frame and the interpolated image frame includes:
detecting a feature in the interpolated image frame using an image-based detection model;
annotating the interpolated image frame to indicate a location of the feature in the interpolated image frame; and
training the DAR-based detection model based on the DAR frame and the annotated interpolated image frame.

7. The method of claim 1, wherein the feature detection model is an image-based detection model, and training the feature detection model using the DAR frame and the interpolated image frame includes:
detecting a feature in the DAR frame using a DAR-based detection model;
annotating the DAR frame to indicate a location of the feature in the DAR frame; and
training the image-based detection model based on the interpolated image frame and the annotated DAR frame.

8. The method of claim 1, further comprising detecting a feature in a joint FOV of the camera and the DAR sensor based on the DAR frame and the interpolated image frame, using a multi-sensor fusion (MSF) feature detection model.

9. The method of claim 1, wherein the DAR sensor is a radio detection and ranging (radar) sensor.

10. The method of claim 1, wherein the DAR sensor is a light detection and ranging (lidar) sensor.

11. The method of claim 1, wherein the camera and the DAR sensor are sensors of a vehicle.

12. An apparatus for multi-sensor training of a feature detection model, comprising:
at least one processor; and
at least one memory communicatively coupled with the at least one processor and storing processor-readable code that, when executed by the at least one processor, is configured to:
obtain a detection-and-ranging (DAR) frame captured by a DAR sensor;
obtain a first image frame captured at a first time by a camera and a second image frame captured at a second time by the camera, wherein at a capture time of the DAR frame, a field-of-view (FOV) of the DAR sensor overlaps an FOV of the camera, and wherein the capture time of the DAR frame is between the first time and the second time;
interpolate based on the first image frame and the second image frame to create an interpolated image frame, wherein a nominal capture time of the interpolated image frame corresponds to the capture time of the DAR frame; and
train the feature detection model using the DAR frame and the interpolated image frame.

13. The apparatus of claim 12, wherein to interpolate based on the first image frame and the second image frame, the processor-readable code is, when executed by the at least one processor, configured to interpolate using a generative machine-learning model.

14. The apparatus of claim 13, wherein the generative machine-learning model is a generative adversarial network (GAN) model.

15. The apparatus of claim 12, wherein to interpolate based on the first image frame and the second image frame, the processor-readable code is, when executed by the at least one processor, configured to implement an image capture timing gradient across a dimension in the interpolated image frame based on a DAR capture timing gradient associated with the dimension in the DAR frame.

16. The apparatus of claim 15, wherein the DAR capture timing gradient is associated with a motion rate of the FOV of the DAR sensor with respect to the dimension.

17. The apparatus of claim 12, wherein the feature detection model is a DAR-based detection model, and wherein to train the feature detection model using the DAR frame and the interpolated image frame, the processor-readable code is, when executed by the at least one processor, configured to:
detect a feature in the interpolated image frame using an image-based detection model;
annotate the interpolated image frame to indicate a location of the feature in the interpolated image frame; and
train the DAR-based detection model based on the DAR frame and the annotated interpolated image frame.

18. The apparatus of claim 12, wherein the feature detection model is an image-based detection model, and wherein to train the feature detection model using the DAR frame and the interpolated image frame, the processor-readable code is, when executed by the at least one processor, configured to:
detect a feature in the DAR frame using a DAR-based detection model;
annotate the DAR frame to indicate a location of the feature in the DAR frame; and
train the image-based detection model based on the interpolated image frame and the annotated DAR frame.

19. The apparatus of claim 12, wherein the processor-readable code is, when executed by the at least one processor, further configured to detect a feature in a joint FOV of the camera and the DAR sensor based on the DAR frame and the interpolated image frame, using a multi-sensor fusion (MSF) feature detection model.

20. The apparatus of claim 12, wherein the DAR sensor is a radio detection and ranging (radar) sensor.

21. The apparatus of claim 12, wherein the DAR sensor is a light detection and ranging (lidar) sensor.

22. The apparatus of claim 12, wherein the camera and the DAR sensor are sensors of a vehicle.

23. An apparatus for multi-sensor training of a feature detection model, comprising:
means for obtaining a detection-and-ranging (DAR) frame captured by a DAR sensor;
means for obtaining a first image frame captured at a first time by a camera and a second image frame captured at a second time by the camera, wherein at a capture time of the DAR frame, a field-of-view (FOV) of the DAR sensor overlaps an FOV of the camera, and wherein the capture time of the DAR frame is between the first time and the second time;
means for interpolating based on the first image frame and the second image frame to create an interpolated image frame, wherein a nominal capture time of the interpolated image frame corresponds to the capture time of the DAR frame; and
means for training the feature detection model using the DAR frame and the interpolated image frame.

24. The apparatus of claim 23, wherein the means for interpolating based on the first image frame and the second image frame includes means for interpolating using a generative machine-learning model.

25. The apparatus of claim 24, wherein the generative machine-learning model is a generative adversarial network (GAN) model.

26. The apparatus of claim 23, wherein the means for interpolating based on the first image frame and the second image frame includes means for implementing an image capture timing gradient across a dimension in the interpolated image frame based on a DAR capture timing gradient associated with the dimension in the DAR frame.

27. The apparatus of claim 23, wherein the feature detection model is a DAR-based detection model, and the means for training the feature detection model using the DAR frame and the interpolated image frame includes:
means for detecting a feature in the interpolated image frame using an image-based detection model;
means for annotating the interpolated image frame to indicate a location of the feature in the interpolated image frame; and
means for training the DAR-based detection model based on the DAR frame and the annotated interpolated image frame.

28. The apparatus of claim 23, wherein the feature detection model is an image-based detection model, and the means for training the feature detection model using the DAR frame and the interpolated image frame includes:
means for detecting a feature in the DAR frame using a DAR-based detection model;
means for annotating the DAR frame to indicate a location of the feature in the DAR frame; and
means for training the image-based detection model based on the interpolated image frame and the annotated DAR frame.

29. The apparatus of claim 23, further comprising means for detecting a feature in a joint FOV of the camera and the DAR sensor based on the DAR frame and the interpolated image frame, using a multi-sensor fusion (MSF) feature detection model.

30. A non-transitory computer-readable medium storing instructions for multi-sensor training of a feature detection model, the instructions including code to:
obtain a detection-and-ranging (DAR) frame captured by a DAR sensor;
obtain a first image frame captured at a first time by a camera and a second image frame captured at a second time by the camera, wherein at a capture time of the DAR frame, a field-of-view (FOV) of the DAR sensor overlaps an FOV of the camera, and wherein the capture time of the DAR frame is between the first time and the second time;
interpolate based on the first image frame and the second image frame to create an interpolated image frame, wherein a nominal capture time of the interpolated image frame corresponds to the capture time of the DAR frame; and
train the feature detection model using the DAR frame and the interpolated image frame.
